(19) United States
(12) Patent Application Publication
(10) Pub. No.: US 2011/0043934 A1
(43) Pub. Date: Feb. 24, 2011

(54) Rotary-Driven Mechanism for Non-Rotational Linear Actuation

(76) Inventors: Bruce C. SUN, Fremont, CA (US); Tzong-Shii Pan, San Jose, CA (US)

Correspondence Address: PILLSBURY WINTHROP SHAW PITTMAN LLP, P.O. BOX 10500, MCLEAN, VA, 22102, US

(21) Appl. No.: 12/769,986

(22) Filed: Apr. 29, 2010

Related U.S. Application Data
(60) Provisional application No. 61/214,945, filed on Apr. 29, 2009.
(60) Provisional application No. 61/279,129, filed on Oct. 15, 2009.

(51) Int. Cl. G02B 7/02; B23P 11/02; B23P 11/00

(52) U.S. Cl. 359/824; 29/446; 29/428; 29/458

(57) ABSTRACT

Actuation mechanisms driven by rotary motors are described whereby linear movement of a mechanical component, typically a lens barrel, is effected without rotating the linear moving component. For mechanisms driven by miniature piezoelectric motors, this is accomplished by driving a rotor which in turn causes linear, and only linear, movement of a lens barrel according to structures described in different embodiments. A preferred embodiment includes a threaded rotor moving both rotationally and axially that drives a two-piece lens barrel assembly. Another embodiment includes a rotor having a grooved split ring on its outer surface that does not move axially and drives a lens barrel through a threaded interface. Another embodiment includes a two-piece rotor that does not move axially and drives a lens barrel through a threaded interface. Typically, anti-rotation pins and corresponding grooves in a fixed structure are used to prevent the lens barrel from rotating.

### CROSS-REFERENCE TO RELATED APPLICATIONS

This application claims the benefit and priority of U.S. Provisional Application No. 61/214,945, filed on Apr. 29, 2009, and entitled “Ultra High-Precision Linear Driving Mechanism Using Miniature Piezoelectric Motors”, and U.S. Provisional Application No. 61/279,129, filed on Oct. 15, 2009, and entitled “Rotary-Driven Mechanism for Non-Rotational Linear Lens Barrel Actuation”, both of said Provisional Applications commonly assigned with the present application and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to the field of electrical motors, motor technology, and actuation mechanisms, as well as camera lenses and actuation mechanisms that move and/or rotate camera lenses.

### BACKGROUND OF THE INVENTION

Different mechanisms are known to drive miniature lens assemblies in order to change the focal length for auto-focus and/or zoom functionalities. Different forms of electromagnetically driven assemblies are used, and many of these operate in a linear fashion. It is desirable to move a lens in and out in a longitudinal direction to adjust focus or zoom parameters while the same time not rotating the lens. Preventing rotation of the lens maintains a consistent optical path, and also provides the ability to perform compensation for lens irregularities knowing that the lens orientation will be maintained as a constant after manufacture relative to its rotational position. At the same time, new technologies using piezoelectric (e.g. PZT, PbZrTi) driven mechanisms are known and have the advantage of extremely small size and low-power consumption. A typical compact example of a PZT driven motor has the ability to drive a rotor in both rotational and longitudinal direction at the same time. Simply placing a lens inside a rotor of this technology would be functional, but would rotate the lens as adjustments are made. Since this rotation is not desirable, a new mechanism is needed to convert the movement of the rotor into purely longitudinal (linear) movement in order to position the lens in the desired manner. At the same time, such a mechanism must be easy to assemble in very high volumes and also very low cost since the market opportunities for such a motor-lens assembly includes not only digital cameras but cameras contained in cellular phones and other computing devices.

### SUMMARY OF THE INVENTION

The present invention relates generally to actuation mechanisms driven by rotary motors whereby linear movement of a mechanical component, for example a lens barrel, is effected without rotating the linear moving component.

According to one aspect, the invention utilizes a rotary electric motor to drive a lens barrel in a longitudinal direction without rotating the lens contained within the lens barrel. To accomplish this, an embodiment of the present invention drives a rotor in both a rotational and longitudinal/axial direction, and the rotor in turn drives a lens barrel in a substantially longitudinal/axial direction. In this embodiment, the rotor is formed to have an outer surface that includes threaded spiral grooves.

One aspect of a preferred embodiment is that the threaded spiral grooves on the outer surface of the rotor intermittently engage with threaded spiral teeth on protrusions that emanate from the inside of an annular shaped stator, and that the forces applied by the protrusions to the rotor's outer surface occur in such a manner as to both rotate the rotor and simultaneously move the rotor in a longitudinal/axial direction.

Another aspect of a preferred embodiment is to provide a circumferential ridge on the interior of the rotor that engages with a circumferential groove on the exterior surface of the lens barrel (lens carrier) such that longitudinal movement of the rotor will move the lens barrel in a longitudinal direction.

Another aspect of a preferred embodiment is that to provide for ease of assembly, the lens barrel is constructed in two portions, a top half and a bottom half. In order to assemble a lens barrel with a rotor, the top half of the lens barrel is inserted into one end of the rotor, while the bottom half of the lens barrel is inserted into the opposite end of the rotor. The two halves of the lens barrel after assembly remain as a rigid one-piece structure by way of a press-fit, an adhesive, both a press-fit and an adhesive, or some other appropriate method of attachment.

Another aspect of a preferred embodiment is that the lens barrel additionally includes anti-rotation slots (longitudinal grooves) that engage with anti-rotation pins on a fixed structure such that longitudinal movement of the lens barrel within desired limits is unimpeded, whereas rotational movement of the lens barrel is prevented. This fixed structure may comprise, for example, a top piece of the housing for the motor-lens assembly.

In alternate embodiments that are described herein, an annular stator imparts rotary motion to a concentric rotor that is at least partially contained within the stator, and while rotating, the rotor assembly imparts linear motion to a barrel. The barrel is concentric with and contained at least partially within the rotor assembly and in camera applications, the barrel may contain a lens or lens assembly. The outer surface of the barrel contains threads and anti-rotation longitudinal grooves where the grooves are suitable for engaging with anti-rotation pins having a fixed position relative to the stator. The anti-rotation pins are typically mounted on a structure to which the stator is either directly or indirectly connected in a fixed manner.

In one alternate embodiment, the rotor assembly comprises a cylindrical primary component and a grooved cylindrical ring, where the grooved cylindrical ring is attached to the outer surface of the cylindrical primary component, and where circumferential grooves on the outer surface of the grooved cylindrical ring are suitable for engagement with grooved teeth on the inner surface of the stator. The grooved cylindrical ring may be split to allow it to be deformed for assembly within the stator.

In another alternate embodiment, the rotor assembly comprises a cylindrical two-piece component where a portion of a first piece fits inside a portion of a second piece when the two pieces are joined to form the rotor assembly. The juncture of the two pieces forms a circumferential groove on the outer surface of the rotor assembly when joined. The two pieces are inserted into the stator from opposite ends such that once assembled within the stator, the circumferential groove aligns with teeth protruding inward from the stator. The stator is formed from a resilient material and comprises multiple inward protrusions where each such protrusion may comprise a single tooth, such that when the rotor is assembled within the stator and the stator is caused to deform, the teeth intermittently engage the surface of the rotor within the circumferential groove causing the rotor assembly to rotate.

In addition, a method for attaching PZT elements to a stator is described that prevents inadvertent shorting by misplaced conductive adhesive.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 shows how for one preferred embodiment a two-piece lens barrel assembly is joined to create a one-piece lens barrel structure having a circumferential groove.

FIG. 2 shows how the two-piece lens barrel is assembled with the rotor.

FIG. 3 shows the lens barrel and rotor along with the stator which drives the rotor, also indicating the directions of motion of the rotor and the lens barrel.

FIG. 4 shows how anti-rotational slots (longitudinal grooves) in the lens barrel engage with anti-rotation pins in the top piece of the housing for the motor-lens assembly.

FIG. 5 shows a complete motor and lens barrel assembly including its housing assembly which includes a bottom and top piece.

FIG. 6 shows a cross-section of the motor-lens assembly without the housing assembly.

FIG. 7 shows an alternative embodiment where the rotor includes a split cylindrical ring attached on the outer surface of a cylindrical primary component and designed to engage with protrusions emanating from the inner surface of the stator.

FIG. 8 shows the split cylindrical ring of FIG. 7 inserted within the stator after deformation of the cylindrical ring to enable assembly.

FIG. 9 shows the rotor installed within the split cylindrical ring and attached thereto.

FIG. 10 shows the completed rotor including split cylindrical ring installed within the stator.

FIG. 11 shows the assembly of FIG. 10 with a lens barrel installed within the rotor.

FIG. 12 shows the assembly of FIG. 11 inserted in a lower housing portion.

FIG. 13 shows the assembly of FIG. 12 with an upper housing portion attached to complete the overall assembly.

FIG. 14 shows another embodiment of the invention where a two-piece rotor assembly is designed for assembly within a stator such that a circumferential groove on the outer surface of the rotor engages with protrusions emanating from the inner surface of the stator.

FIG. 15 shows the two-pieces of the rotor assembly of FIG. 14 prior to being joined.

FIG. 16 shows the two-piece rotor assembly of FIG. 15 after joining.

FIG. 17 shows the stator of FIG. 14 with one alternative for the shape of the inner-facing protrusions.

FIG. 18 shows the embodiment of FIG. 14 with emphasis on the assembly process where the upper and lower halves of the two-piece rotor are inserted into the stator from opposite directions.

FIG. 19 shows the assembly of FIG. 18 where a first half of the rotor it has already been inserted within the stator and the second half of the rotor is about to be inserted and joined with the first half.

FIG. 20 shows the stator of FIG. 19 with both halves of the rotor installed within.

FIG. 21 shows the assembly of FIG. 20 with a lens barrel having been screwed into it.

FIG. 22 shows the assembly of FIG. 21 having been inserted into a lower portion of the housing.

FIG. 23 shows the assembly of FIG. 22 with the upper portion of the housing installed to complete the overall assembly.

FIG. 24 shows a stator according to an embodiment of the present invention where a circular groove has been added on the surface of each facet of the stator such that conductive and non-conductive adhesives may be added at specific locations in order to attach a PZT element while making proper electrical contact and at the same time not shorting the PZT element due to excessive or misplaced adhesive.

FIG. 25 shows a close-up detail of the stator of FIG. 24 with emphasis on one type of circular groove that may be formed in the surface of a facet of the stator prior to the addition of conductive and nonconductive adhesives used to join a PZT element to the facet.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Embodiments of the invention relate to structures and assembly methods of actuation mechanisms driven by rotary motors whereby linear movement of a mechanical component, for example a lens barrel, is effected without rotating the linear moving component. In example mechanisms which are driven by miniature piezoelectric motors, this desired feature is accomplished by driving a rotor which in turn causes linear, and only linear, movement of a lens barrel. Various structures and assembly methods for accomplishing this desired feature are described in different embodiments hereinbelow.

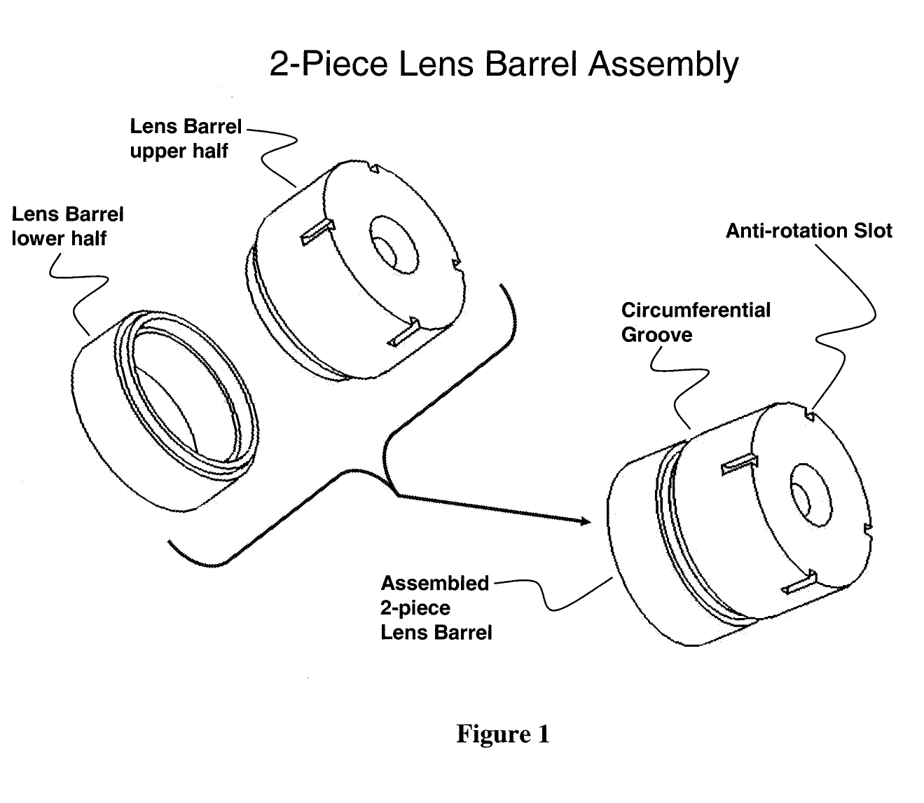

FIG. 1 illustrates one example actuation mechanism according to embodiments of the invention. For example, FIG. 1 shows a two-piece lens barrel assembly where lens barrel lower half 101 and lens barrel upper half 102 are joined to form a single piece lens barrel 103 having a circumferential groove 104 which is designed to accept a circumferential ridge protruding from the interior surface of the rotor. Note that the assembled lens barrel 103 in this example contains anti-rotation grooves 105.

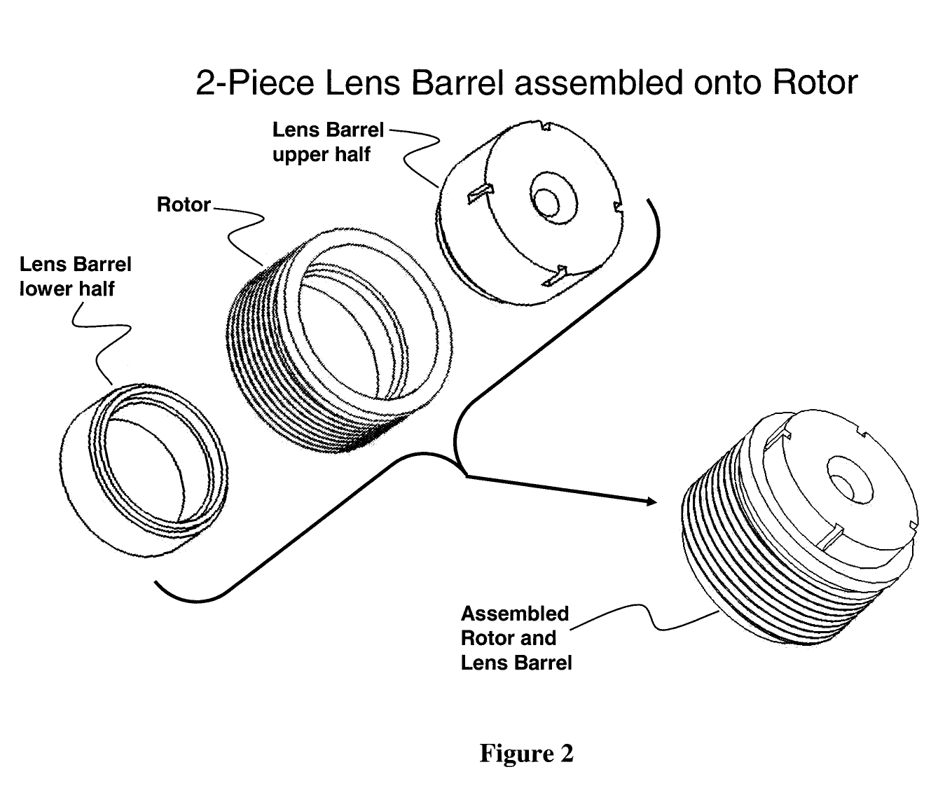

FIG. 2 shows an example of how the two-piece lens barrel 103 of FIG. 1 is assembled within the rotor 201. One half of lens barrel 101 is inserted in one end of rotor 201 while the other half of lens barrel 102 is inserted in the opposite end of rotor 201. When the two halves of the lens barrel are assembled by press-fit, adhesive, a combination of these or other appropriate methods, rotor 201 is then free to turn about the lens barrel in a rotational direction, however any longitudinal/axial movement of the rotor about its center axis will cause circumferential ridge 204 to engage with groove 104 in the assembled lens barrel 103 (shown in FIG. 1) and hence cause the lens barrel to move longitudinally/axially. The two-piece lens barrel assembled within the rotor is shown as assembly 205.

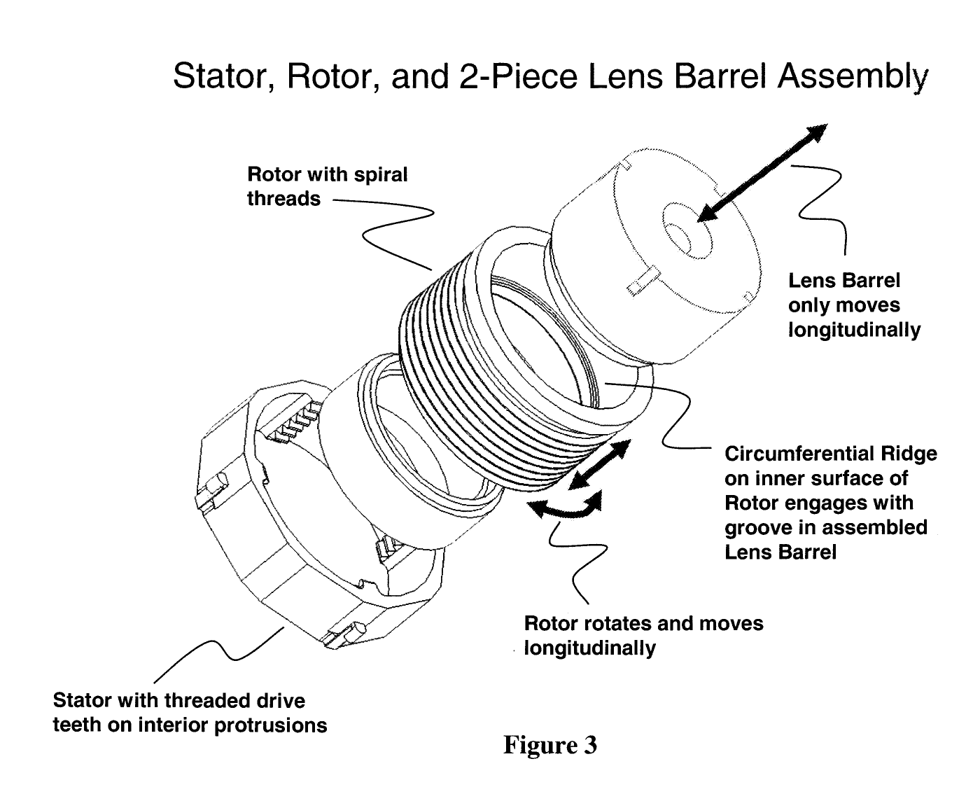

FIG. 3 shows an example configuration of rotor 201 and lens barrel assembly 103 along with stator 303. In the embodiment shown, the annular stator 303 is comprised of a resilient material and is actuated by piezoelectric (PZT) elements attached to faceted surfaces 304 such that when different PZT elements are electrically excited in a specific sequence, the stator deforms causing teeth on protrusions 305 to engage with the threaded outside surface of rotor 301. The deformation of the stator is caused to occur in an asymmetrical mariner such that forces are applied to the rotor, causing the rotor to rotate, and by virtue of the angle of the spiral threads on both the rotor and the teeth protruding from the stator, also causing the rotor to also move slightly in a longitudinal or axial direction. The circumferential ridge 204 formed on the inner surface of the rotor then engages with the circumferential groove 104 (not shown) on the outer surface of assembled lens barrel assembly 103, thus driving the lens barrel axially. The sequence and pattern of deformation of the stator is controlled by applying different voltages to different PZT elements at different times, and as such the direction of rotation of the rotor may be chosen and controlled by this manner of applying voltages. It should be understood that other mechanisms are possible for driving a rotor such that it rotates in a circumferential direction while simultaneously moving in a longitudinal or axial direction. Thus, the lens barrel actuation mechanism described herein may be combined with other motor drive mechanisms and still fall within the scope of the appended claims. Although the application described herein is for positioning of a camera lens, the barrel may perform a different function in a different application and still fall within the scope of the appended claims.

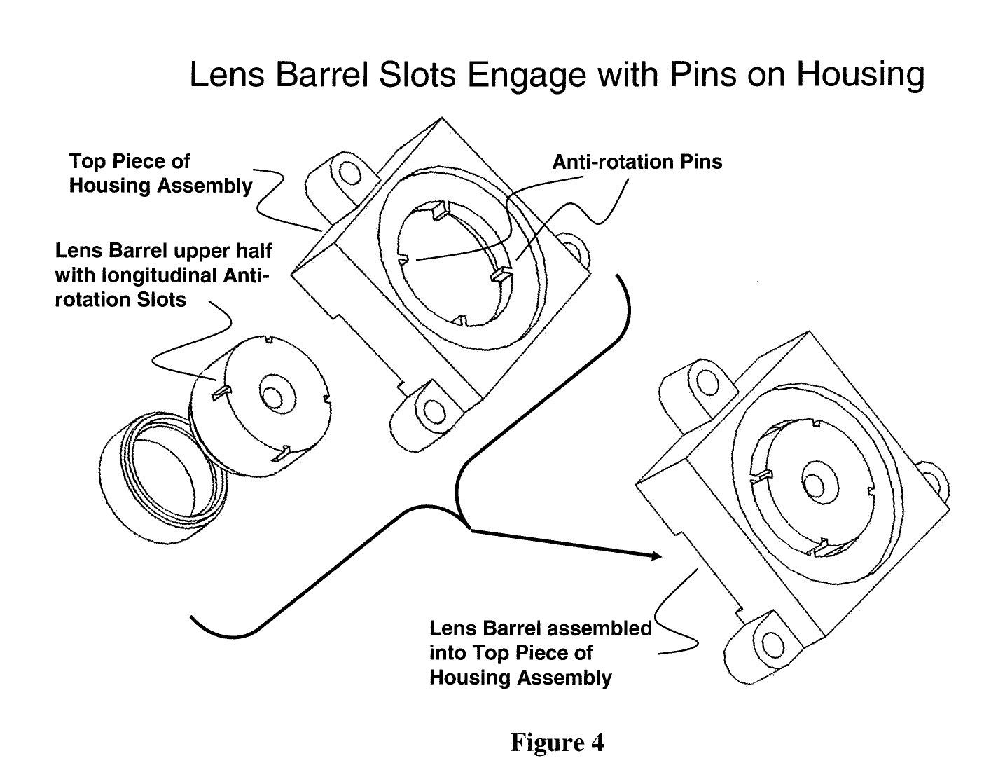

FIG. 4 shows an example of how lens barrel assembly 401 fits inside top housing piece 402 where anti-rotation grooves 105 on assembled lens barrel assembly 103 engage with anti-rotation pins or teeth 404 emanating from the inner surface of the opening in the top housing piece 402. These anti-rotation pins or teeth 404 therefore allow longitudinal/axial movement of the lens barrel while preventing rotation.

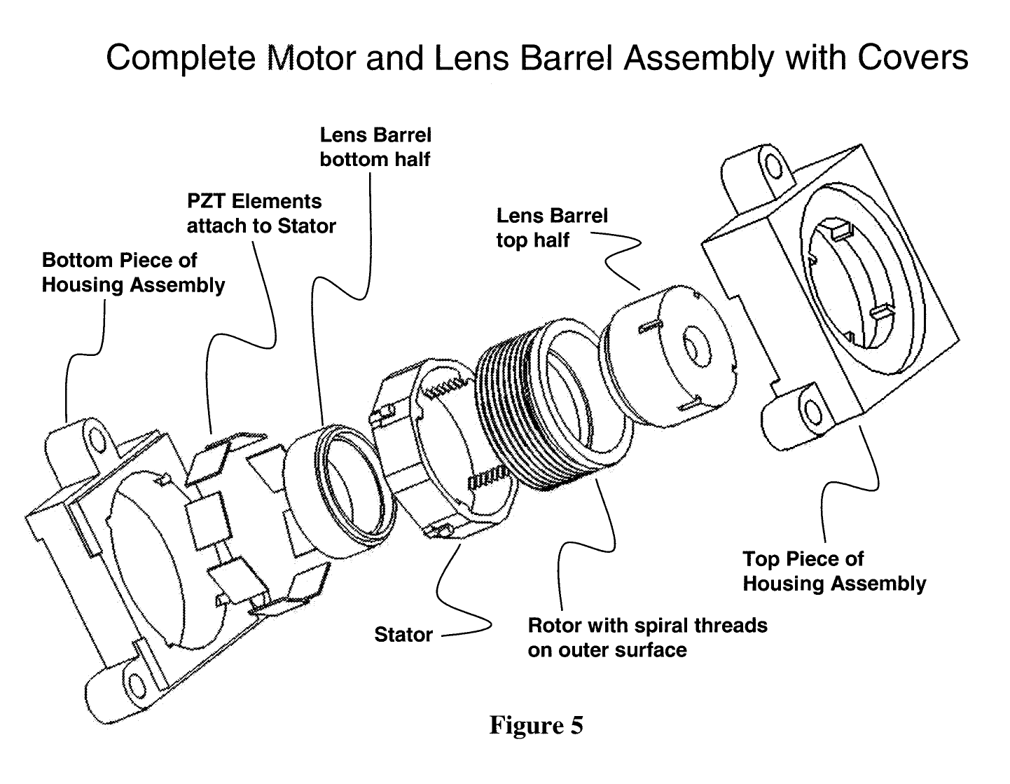

FIG. 5 shows an example of a complete motor and lens barrel assembly including top piece 402 and bottom piece 502 of the housing. In this particular embodiment as shown, stator 303 is designed with facets 304 on the outer circumferential surface, these facets being designed to accept PZT elements 504 which are driven by an electronic controller circuit in a manner that causes deformation of the stator. The grooved spiral teeth on the protrusions 305 that emanate from the interior surface of the stator engage with the outer threaded surface of rotor 201 causing the rotor to both rotate and move longitudinally/axially. The circumferential ridge 204 emanating from the interior surface of the rotor then drives longitudinal movement of the lens barrel by virtue of contact with the circumferential groove 104 on the lens barrel outer surface (not shown). Finally the lens barrel is prevented from rotating by virtue of engagement with anti-rotation pins 404 shown in this embodiment in top cover 402, these pins essentially in a fixed position relative to stator 303. Other methods of enclosing the motor and lens barrel assembly are possible and the top and bottom housing pieces shown in FIG. 5 are just one example shown for enabling those skilled in the art. In order to prevent rotation of the lens barrel assembly, some form of anti-rotation slot(s) (longitudinal grooves or groove) would be included at some locations or location on the lens barrel assembly, and these anti-rotation slot(s) would engage anti-rotation pin(s) somehow mounted in a fixed location relative to the stator and motor-lens assembly.

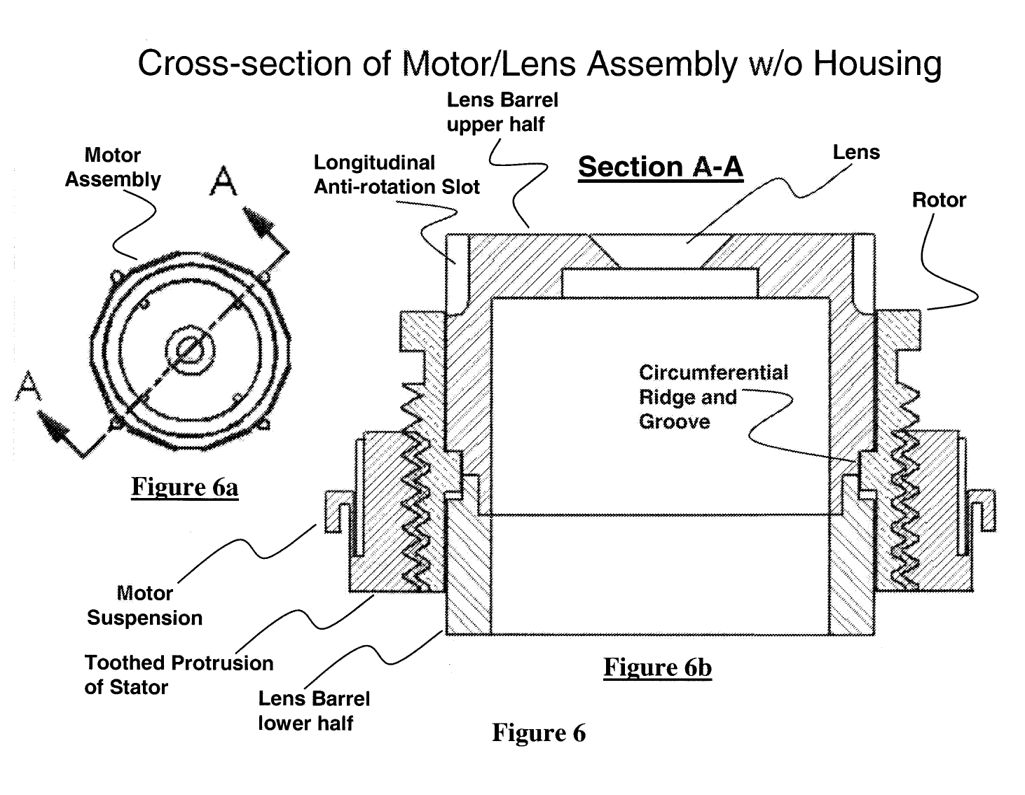

FIGS. 6A and 6B show a cross-section of the example motor-lens assembly such as that shown in FIG. 5 with the top and bottom housing pieces of FIG. 5 removed for clarity. More particularly, the cross-section shown in FIG. 6B is cut per FIG. 6A through the assembly at the point where motor suspension springs 601 are located on the outer circumference of the stator 303. These motor suspension springs 601 are visible at the far left and right of FIG. 6B. The cross-section also cuts the stator 303 at the point where toothed protrusions 305 emanate from the interior surface of the stator and as shown in FIG. 6B engage matching threaded teeth in the outer surface of rotor 201. As the PZT elements on the stator are driven causing the stator to deform asymmetrically, these toothed protrusions will alternately engage and disengage with the rotor and while engaged apply force to the surface of the rotor causing it to rotate slightly. Also shown in the cross-section of FIG. 6B is circumferential groove 104 formed in lens barrel assembly 103 and the circumferential ridge on the interior surface of the rotor which engages with this groove. At the top of FIG. 6B is a longitudinal anti-rotation groove or slot 105 shown in cross-section at each side of the rotor, these slots designed to engage with anti-rotation pins or teeth 404 of the top piece of the housing assembly (as shown in FIG. 4).

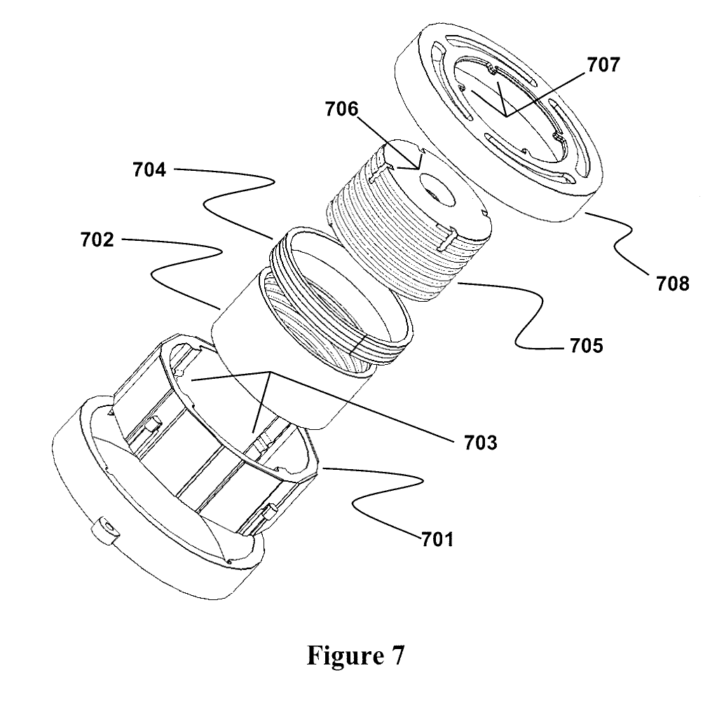

FIG. 7 shows an alternative embodiment where stator 701 drives rotor 702 in a substantially rotational direction by way of teethed protrusions 703 on the inner surface of stator 701 which engage with grooved split ring 704 which is attached to the primary component of rotor 702. As rotor 702 rotates, lens barrel 705 is caused to move in an axial direction by virtue of its threaded outer surface engaging with the threaded inner surface of rotor 702. Lens barrel 705 is prevented from rotating by virtue of anti-rotation grooves 706 which engage with anti-rotation teeth 707 in top cover housing 708 which is held in a fixed position relative to stator 701.

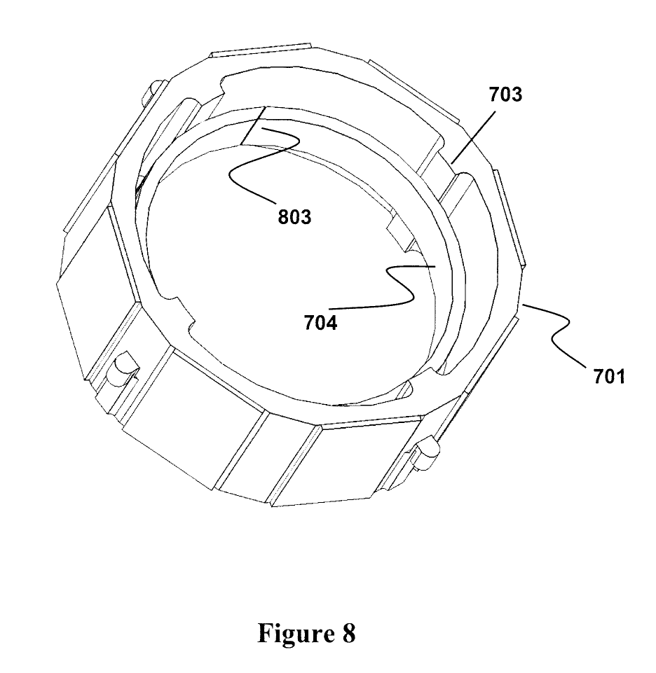

Further aspects, and an example assembly method of the embodiment of FIG. 7 will be described beginning with FIG. 8. FIG. 8 shows an example of grooved split ring 704 having a grooved outer circumferential surface as shown in FIG. 7, and as shown, the split ring having been inserted into stator 701 such that grooved teeth 703 protruding from the inner surface of the stator have engaged with grooves (not shown) on the outer surface of split ring 704. In order to assemble split ring 704 into the position shown within stator 701, split ring 704 must be deformed such that an opening is formed at split location 803 allowing the effective diameter of split ring 704 to be temporarily reduced while it is inserted within stator 701.

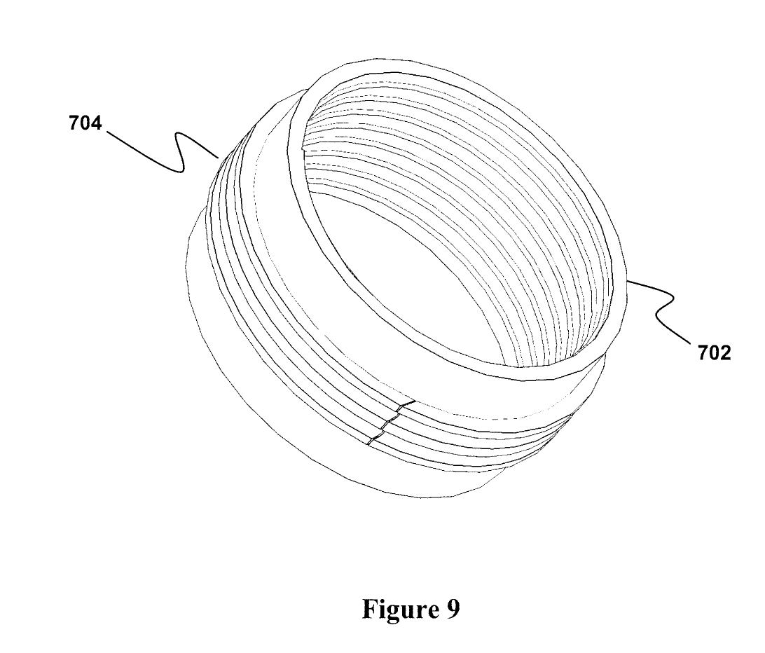

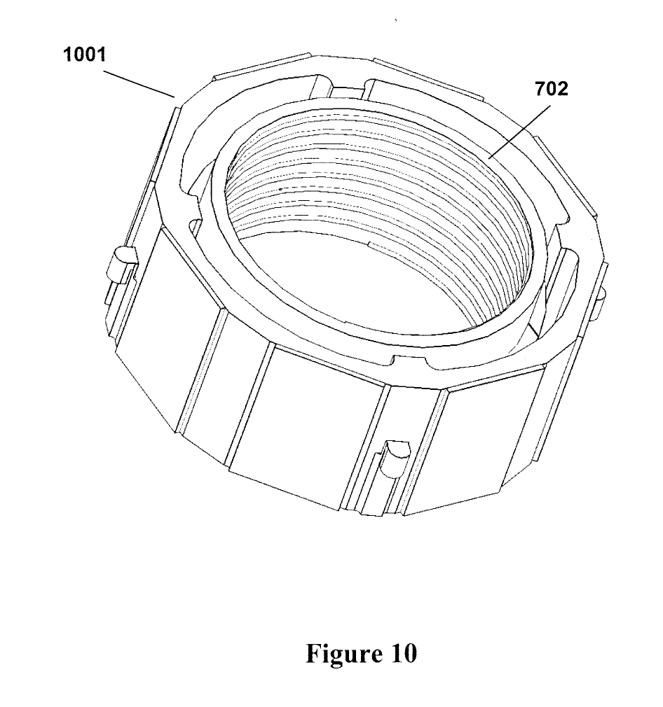

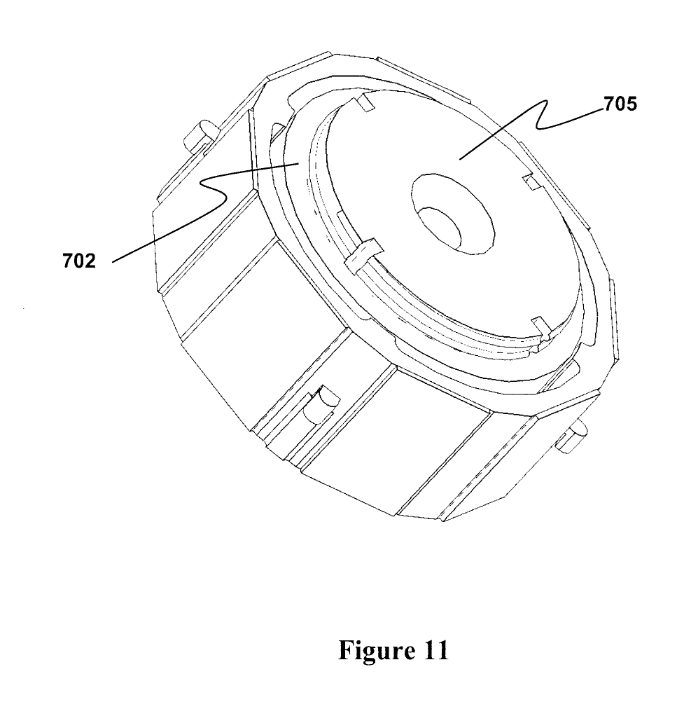

After the split ring has been inserted within the stator per FIG. 8, as shown in FIG. 9 the cylindrical primary component of the rotor 702 will be inserted within split ring 704 and permanently attached thereto, the complete assembly 1001 up to this point being as shown in FIG. 10. Subsequently lens barrel 705 is screwed into rotor 702 resulting in the example assembly as shown in FIG. 11.

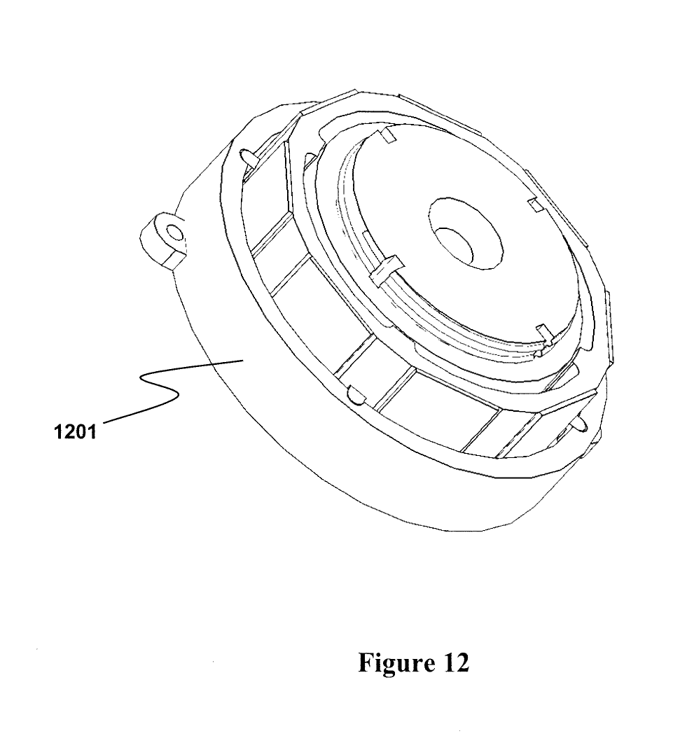

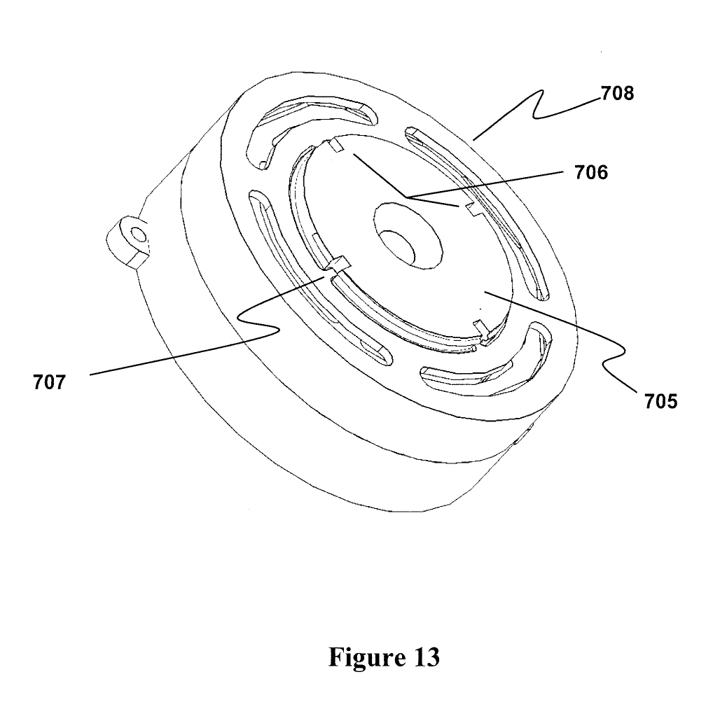

The example assembly as shown in FIG. 11 is then inserted within the lower housing portion 1201 as shown in FIG. 12. Finally, upper housing portion 708 is added to the assembly as shown in FIG. 13 with anti-rotation pins 707 in upper housing 708 engaging with anti-rotation grooves 706 located on lens barrel 705.

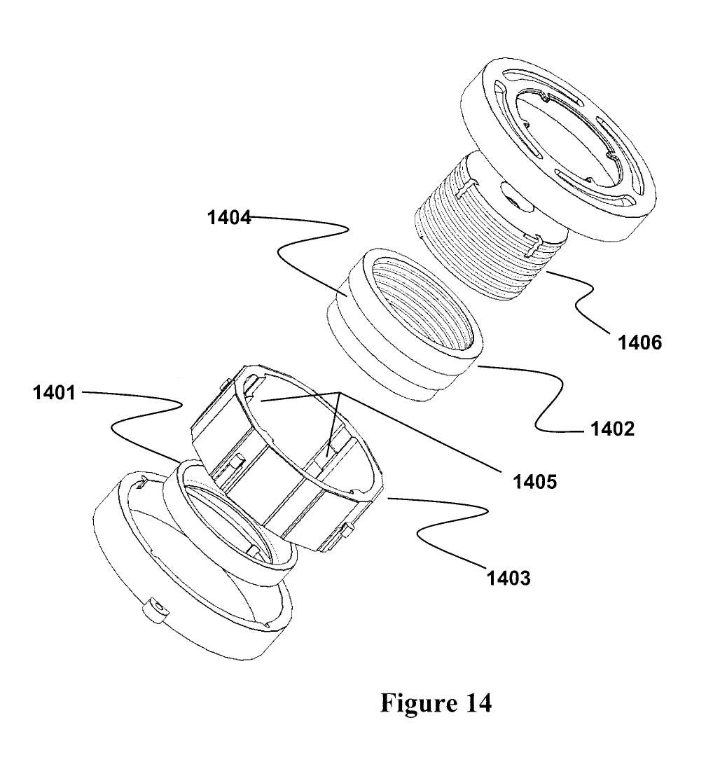

Another alternative embodiment is shown in FIG. 14. Here, the rotor is comprised of first and second portions 1401 and 1402 which are joined within stator 1403 such that a circumferential groove 1404 formed on the outer surface of the assembled rotor engages with protrusions 1405 emanating inward from the inner surface of stator 1403. Thus, the assembled rotor is caused to rotate in turn causing lens barrel 1406 to move axially.

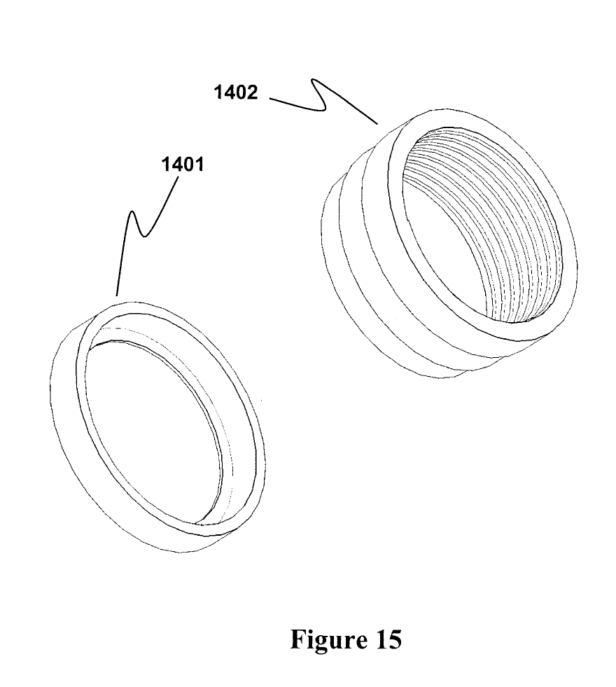

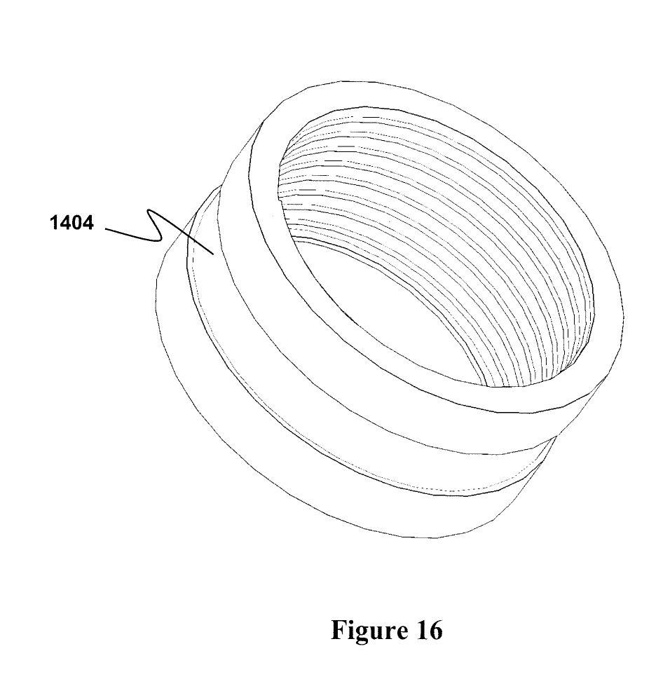

Further aspects, and an example assembly method of the embodiment of FIG. 14 will be described beginning with FIG. 15. FIG. 15 shows upper and lower portions 1401 and 1402 of the rotor prior to assembly, respectively, while FIG. 16 shows the rotor after assembly including circumferential groove 1404 formed on the outer surface.

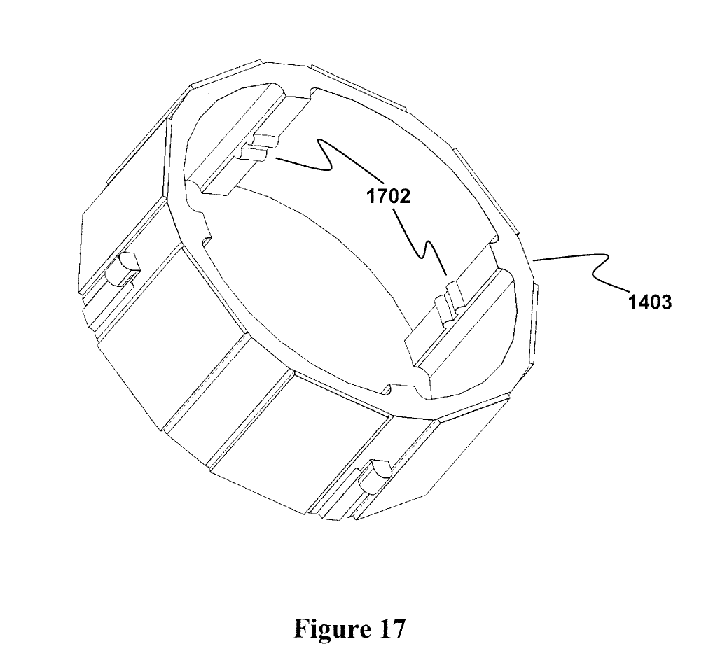

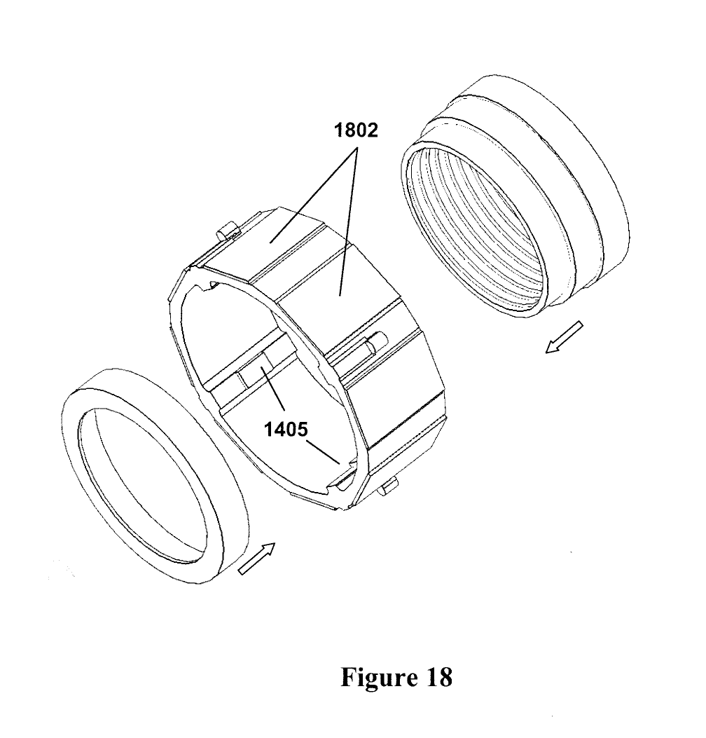

FIG. 17 shows stator 1403 including protrusions 1702 emanating from the inner surface of the stator. The protrusions may take the form of multiple bumps 1702 as shown in FIG. 17 or alternately may comprise a single bump 1405 as shown in FIG. 18 and similarly in FIG. 14. Regardless of the configuration of these protrusions, they engage with the circumferential groove formed in the rotor after the rotor is assembled within the stator, causing the rotor to rotate when the stator is deformed as a result of electrical stimulation of PZT elements attached to facets 1802 on the stator. In this embodiment, the rotor does not move axially. It only rotates.

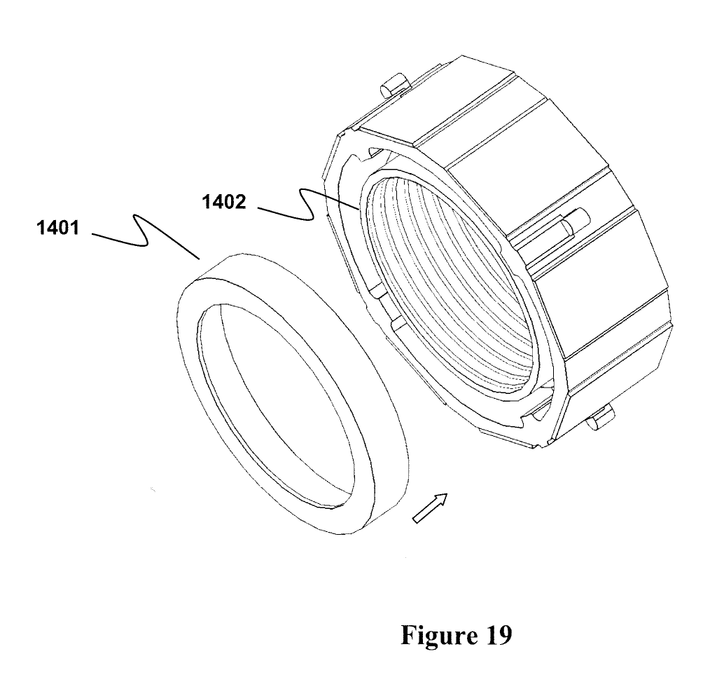

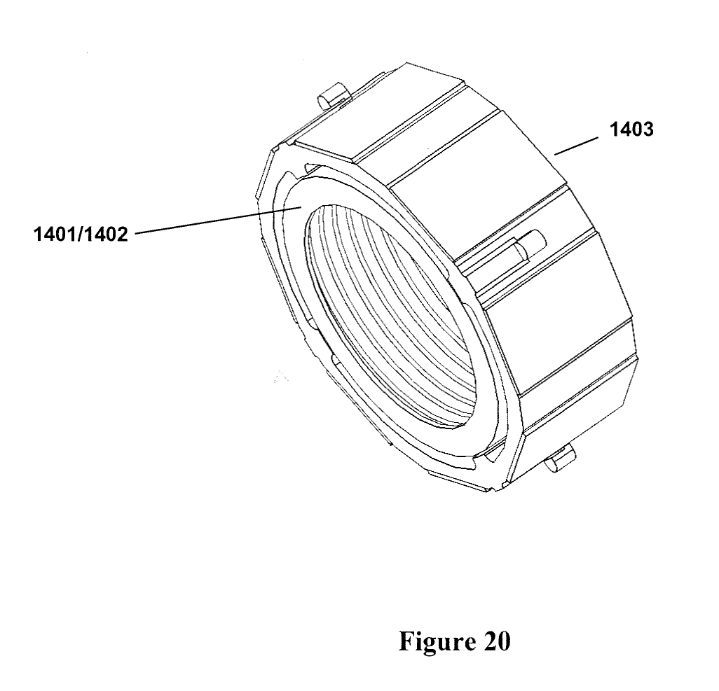

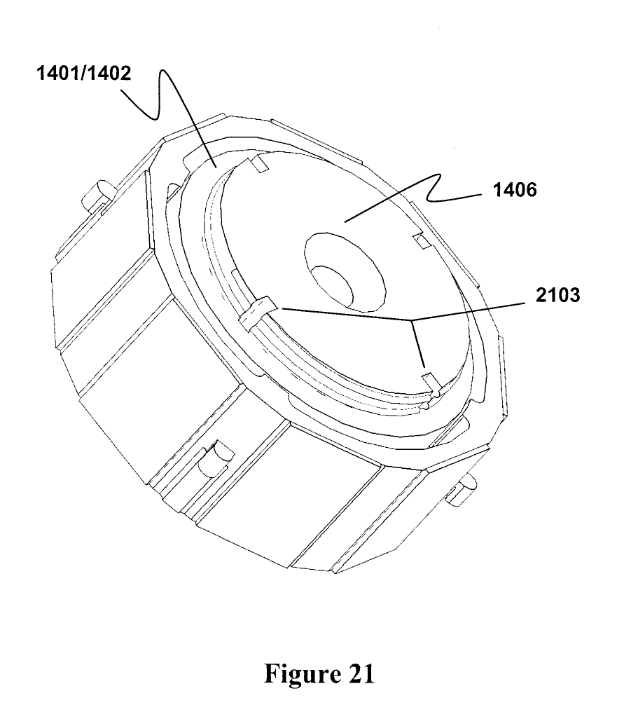

FIG. 19 shows the final step of assembly of the two-piece rotor being assembled within the stator. Here, the bottom portion of rotor 1401 is attached to the upper portion of the rotor 1402 such that the circumferential groove thus formed on the outer surface of the rotor will engage with protrusions emanating from the inner surface of the stator. FIG. 20 shows the rotor fully assembled within the stator 1403. FIG. 21 shows the assembly of FIG. 20 with the addition of lens barrel 1406 which has been screwed into rotor 1401/1402. Note the anti-rotation grooves 2103 formed on lens barrel 1406.

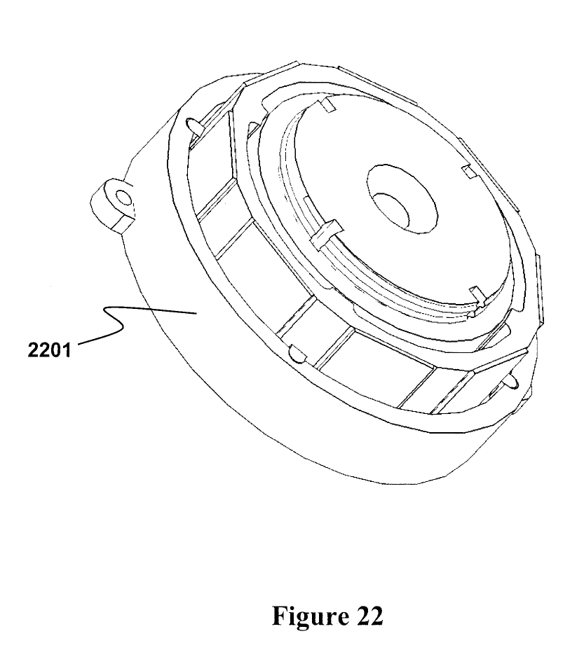

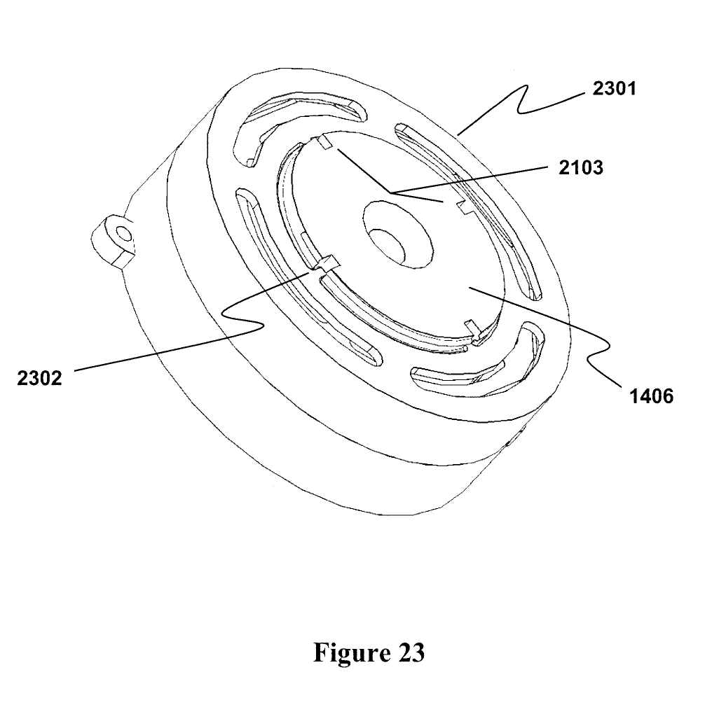

FIG. 22 shows the assembly of FIG. 21 having been inserted into the lower half of a housing 2201. FIG. 23 shows the final assembly with the upper half 2301 of the housing having been added to complete the assembly. Note that anti-rotation pins 2302 on upper housing portion 2301 engage with anti-rotation grooves 2103 formed in lens barrel 1406.

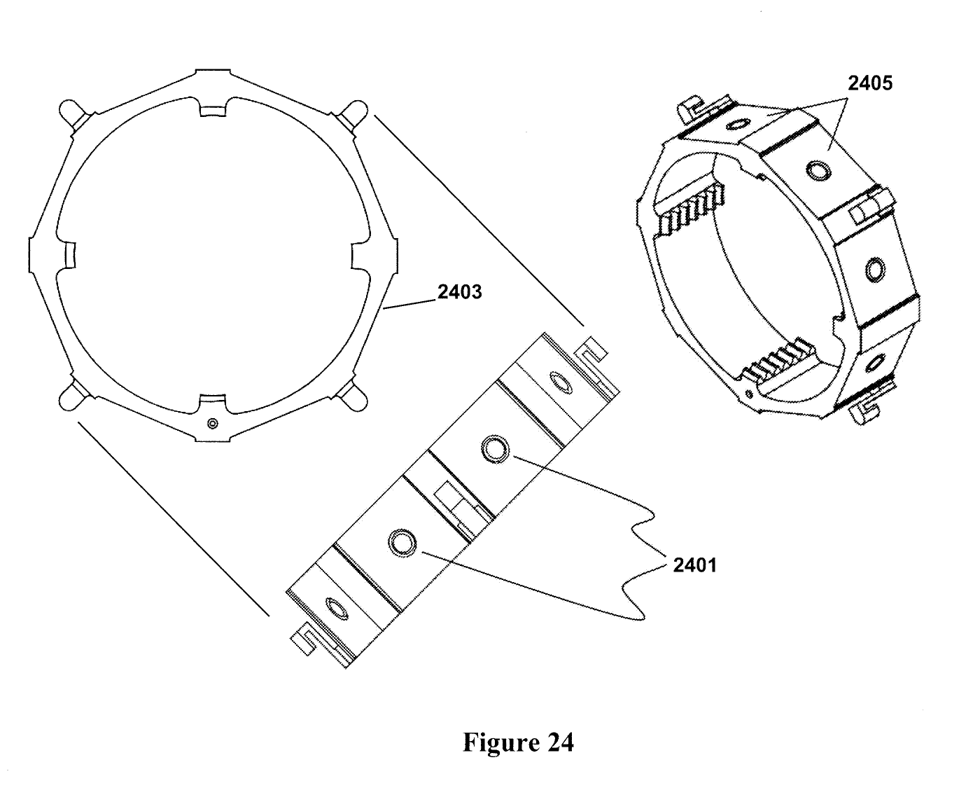

For the embodiments shown herein, the stator is typically comprised of a resilient material and is capable of being deformed according to stresses and strains applied to the stator by PZT elements attached to facets on the outer surface of the stator. Adhesive used to attach these elements to the stator will typically also include the ability to conduct electrical current, as will be appreciated by those skilled in the art. At the same time, PZT elements for embodiments of the invention may be quite thin, creating the possibility for excessive conductive adhesive to be squeezed from the facet attachment point and potentially rise to make contact with the opposite surface of the PZT element, thus shorting it electrically. In order to avoid this situation it can be useful to apply some amount of conductive adhesive in a region near the center of the PZT element being attached, while non-conductive adhesive is utilized in regions of the PZT element near its edges. To facilitate this, as shown in FIG. 24 groove(s) 2401 may be formed on the surface of the stator 2403 in the area of the facets 2405 intended for PZT attachment in order to control the spread of conductive adhesive.

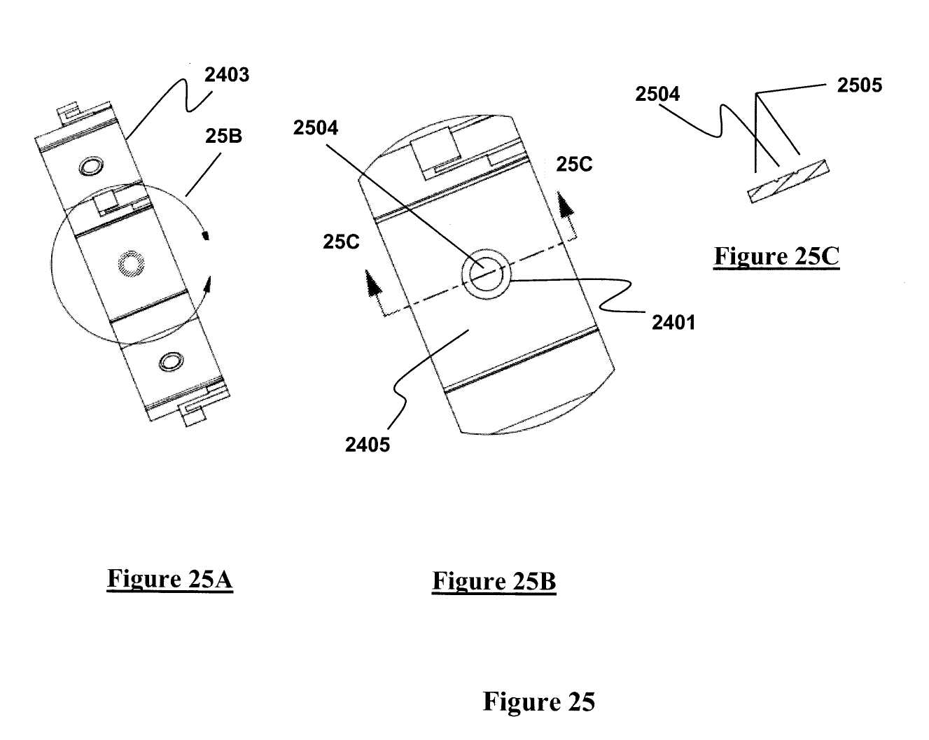

More particularly, FIG. 25A shows a side view of an example stator 2403 with an area marked as detail “25B”. A close-up of the marked area in FIG. 25A is shown in FIG. 25B where a circular groove 2401 is shown. The surface 2504 to the inside of this groove is where conductive adhesive would typically be placed prior to the attachment of a PZT element or pad. The surface of facet 2405 lying outside groove 2503 would be where nonconductive adhesive is typically placed. The cross-section shown in FIG. 25C shows another view of the circular groove and surfaces 2504 within and 2505 outside it. To accomplish the goal of this structure and procedure according to the invention as claimed, groove(s) 2401 may be of any shape as long as they have a tendency to prevent adhesive placed on the surface within from migrating towards the outside of the groove when assembly of a PZT pad or element to the facet surface of the stator is performed. Thus, while such a groove may be referred to as a circular groove, its shape and position on a particular facet may vary with the implementation.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. Structural variations of combinations of features amongst embodiments will also become apparent to those skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. An assembly for converting rotary motion to linear motion, comprising:
an annular stator for imparting rotary motion to a rotor, the rotor concentric with and contained at least partially within the stator;
wherein while rotating, the rotor imparts linear motion to a barrel assembly, the barrel assembly being concentric with and contained at least partially within the rotor;
wherein the barrel assembly contains anti-rotation grooves that engage with anti-rotation pins having a fixed position relative to the stator, and
wherein the outer surface of the rotor comprises threads such that when caused to rotate by the stator, the rotor also moves linearly in an axial direction corresponding to the rotary motion, thereby imparting the linear motion to the barrel assembly.

2. The assembly of claim 1 further comprising a circumferential ridge on an inner surface of the rotor, the ridge engaging a circumferential groove in the barrel assembly.

3. The assembly of claim 2 wherein the barrel assembly is constructed as a two-piece assembly, a juncture of the two pieces being located at the circumferential groove.

4. The assembly of claim 3 wherein a portion of a first of the two pieces fits inside a portion of a second of the two pieces when the two pieces are joined to form the barrel assembly.

5. The assembly of claim 3 wherein the barrel assembly is constructed by inserting a first of the two pieces into an opening on one end of the rotor followed by inserting a second of the two pieces into an opening on the other end of the rotor.

6. The assembly of claim 1 wherein the stator comprises a resilient material and includes inward facing threaded teeth such that when the stator is caused to deform by piezoelectric elements contained therein, the threaded teeth engage with the threads on the outer surface of the rotor thereby applying a force to the rotor to cause the rotor to both rotate and move linearly in the axial direction.

7. An assembly for converting rotary motion to linear motion, comprising:
an annular stator for imparting rotary motion to a rotor assembly, the rotor assembly concentric with and contained at least partially within the stator;
wherein while rotating, the rotor assembly imparts linear motion to a barrel, the barrel being concentric with and contained at least partially within the rotor assembly; and
wherein the outer surface of the barrel contains threads and anti-rotation longitudinal grooves, the grooves suitable for engaging with anti-rotation pins having a fixed position relative to the stator.

8. The assembly of claim 7 wherein at least a portion of the inner surface of the rotor assembly comprises threads such that when the rotor assembly is caused to rotate by the stator, the threads on the inner surface of the rotor assembly impart a linear motion to threads on the outer surface of the barrel, thereby causing the barrel to move in an axial direction corresponding to the rotary motion.

9. The assembly of claim 8 wherein the rotor assembly comprises a cylindrical primary component and a grooved cylindrical ring, the grooved cylindrical ring capable of being attached to the outer surface of the cylindrical primary component, and wherein grooves on the outer surface of the grooved cylindrical ring are suitable for engagement with grooved teeth on the inner surface of the stator.

10. The assembly of claim 9 wherein the grooved cylindrical ring includes a split portion to allow it to be deformed for assembly within the stator such that when thus assembled, the grooved teeth on the inner surface of the stator extend into the grooves on the outer surface of the grooved cylindrical ring.

11. The assembly of claim 10 wherein construction of the assembly includes the method of:
deforming the grooved cylindrical ring such that its diameter is effectively reduced;
inserting the grooved cylindrical ring within the stator such that the grooved teeth on the inner surface of the stator line up with the grooves on the outer surface of the grooved cylindrical ring;
allowing the grooved cylindrical ring to return to its un-deformed state; and
inserting the cylindrical primary component into the grooved cylindrical ring whereby a permanent attachment is formed between the cylindrical primary component and the grooved cylindrical ring.

12. The assembly of claim 8 wherein the rotor assembly comprises a cylindrical two-piece component wherein a portion of a first of the two pieces fits inside a portion of a second of the two pieces when the two pieces are joined to form the rotor assembly.

13. The assembly of claim 12 wherein the juncture of the first and second pieces forms a circumferential groove on the outer surface of the rotor assembly when joined.

14. The assembly of claim 13 wherein the stator is formed from a resilient material and comprises multiple inward protrusions wherein each such protrusion comprises at least one tooth, such that when the rotor is assembled within the stator and the stator is caused to deform, the at least one tooth may engage the surface of the rotor within the circumferential groove causing the rotor assembly to rotate.

15. The assembly of claim 14 wherein the stator comprises multiple piezoelectric elements that when activated cause the stator to deform.

16. The assembly of claim 14 wherein construction of the assembly includes the method of:
inserting the first of the two pieces of the rotor within the stator through an opening on a first side of the stator;
inserting the second of the two pieces of the rotor within the stator through an opening on a second side of the stator; and
joining the first and second pieces of the rotor such that any teeth protruding from the inner surface of the stator are within the circumferential groove on the outer surface of the rotor.

17. A method for assembling PZT elements to a stator, comprising:
forming one or more circular grooves on each surface of the stator where a PZT element is to be attached, each groove enclosing an area on the surface of the stator;
applying conductive adhesive to the surface of the stator within the innermost groove;
applying non-conductive adhesive to the surface of the stator outside the outermost groove; and
attaching a PZT element to the surface of the stator such that the PZT element contacts both the conductive and non-conductive adhesive.

18. A motor, comprising:
an annular stator for imparting rotary motion to a rotor, the rotor being concentric with and contained at least partially within the stator;
wherein while rotating, the rotor imparts linear motion to a barrel assembly, the barrel assembly being concentric with and contained at least partially within the rotor; and
wherein the barrel assembly contains anti-rotation structures formed therein.

19. The motor of claim 18 wherein the anti-rotation structures comprise grooves that engage with anti-rotation pins having a fixed position relative to the stator.
